(19) United States
(12) Patent Application Publication
(10) Pub. No.: US 2014/0307330 A1
(43) Pub. Date: Oct. 16, 2014

(54) LIQUID LENS DRIVING METHOD

(71) Applicant: LUSTROUS ELECTRO-OPTIC CO., LTD., NEW TAIPEI CITY (TW)

(72) Inventor: CHIH-WEI TSAI, HSINCHU CITY (TW)

(73) Assignee: LUSTROUS ELECTRO-OPTIC CO., LTD., NEW TAIPEI CITY (TW)

(21) Appl. No.: 13/951,687

(22) Filed: Jul. 26, 2013

(30) Foreign Application Priority Data
Apr. 10, 2013 (TW) 102112705

(51) Int. Cl. G02B 3/14

(52) U.S. Cl. CPC G02B 3/14
USPC 359/665

(57) ABSTRACT

A liquid lenses driving method to control the focus of a liquid lens by inputting voltages to specific electrodes. The liquid lens includes a first liquid, a second liquid having a lower refractive index than and immiscible with the first liquid, a plurality of driving electrodes (M), an container, and a transparent cover. M is greater than or equal to 2. The first liquid is positioned above the plurality of electrodes. The electrodes are concentrically configured and annular in shape. The outermost electrode is a first electrode and the innermost electrode is an M^{th} electrode. Adjacent electrodes have opposite polarities. When a driving voltage is provided throughout the first electrode to the N^{th} electrode, a base circumference of the first liquid is displaced to an inner circumference of the N^{th} electrode. N is an integer greater than or equal to 1 and smaller than M.

### BACKGROUND OF THE INVENTION

1. Field of the Invention

The instant disclosure relates to a liquid lens driving method; in particular, to a driving method capable of adjusting the focus of the liquid lens.

2. Description of Related Art

Liquid lens is capable of adjusting focus, which includes two immiscible liquids. A pre-determined and axisymmetrically convex interface is formed between the two liquids, in which the convex interface resembles the optical properties of a solid lens having a convex shape.

Typically, the method to drive liquid lens commonly applies voltage on a single group of electrodes such that the liquid to liquid interface changes shape. In addition, by adjusting the value of the input voltage, the curvature of the liquid to liquid interface changes accordingly and successively adjusts the focus of the liquid lens. However, with the aforementioned driving method, the first liquid cannot accurately control the adjustable focus variables due to possible defects or particles on the substrate or deviation in voltage.

### SUMMARY OF THE INVENTION

The instant disclosure provides a liquid lens driving method which adjusts the curved surface of the liquid to liquid interface between a first liquid and a second liquid. The instant method inputs voltages into specifically selected electrode or electrodes such that the base circumference of the first liquid is bounded by the inner circumference of the specifically selected electrode or electrodes. As a result, the curved surface of the first liquid can be accurately controlled, thus, providing specifically selected focus.

The liquid lens comprises two mutually immiscible and transparent liquid, a driving electrode, and a container. The curved liquid to liquid interface formed by the two mutually immiscible liquids is the axisymmetric curved surface of the liquid lens. The driving electrodes are served to provide an electric field to adjust the shape of the interface. Thus, focus of liquid lens can be adjusted. The container serves to seal the two liquids therein.

The driving electrode can be an M number of electrodes, where M is larger or equals to two. The electrodes are concentrically configured annular electrodes. A droplet of the first liquid is disposed above the driving electrodes. The driving electrodes are denoted as the first electrode being the outermost electrode, and the M^{th} electrode as the innermost electrode. Two adjacent electrodes have opposite polarity. When the driving voltage is inputted throughout the first electrode to the N^{th} electrode, base circumference of the first liquid is bounded by the inner circumference of the N^{th} electrode, where N is larger than or equal to 2 and is smaller or equal to M.

In summary, the instant disclosure provides a liquid lens driving method which inputs control voltages via specific voltage input modes to the corresponding driving electrodes in order to control the specific displacement of the base circumference of the first liquid to be bounded by the inner circumference of specific electrodes. The accuracy of the control can be as precise as sub-micron scale to provide precise focus.

Furthermore, by having two voltage input modes, the driving voltage and the holding voltage, fast reaction time and low power consumption are provided.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1A is a top view of a liquid lens driving method in accordance with a first embodiment of the instant disclosure;

FIG. 1B is a cross-sectional view of the liquid lens driving method in accordance with the first embodiment of the instant disclosure;

FIGS. 2 to 2I are schematic diagrams of the liquid lens driving method in accordance with the first embodiment of the instant disclosure;

FIG. 3 is a cross-sectional view of the liquid lens driving method in accordance with a second embodiment of the instant disclosure; and

FIGS. 4 to 4I are schematic diagrams of the liquid lens driving method in accordance with the second embodiment of the instant disclosure.

### DETAILED DESCRIPTION OF THE PREFERRED EMBODIMENTS

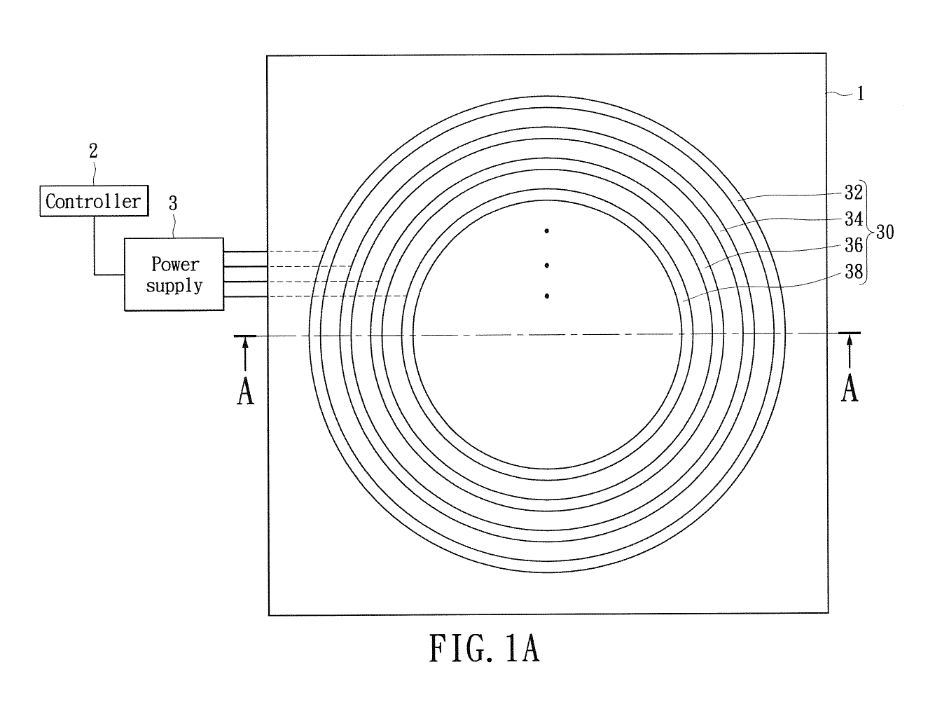

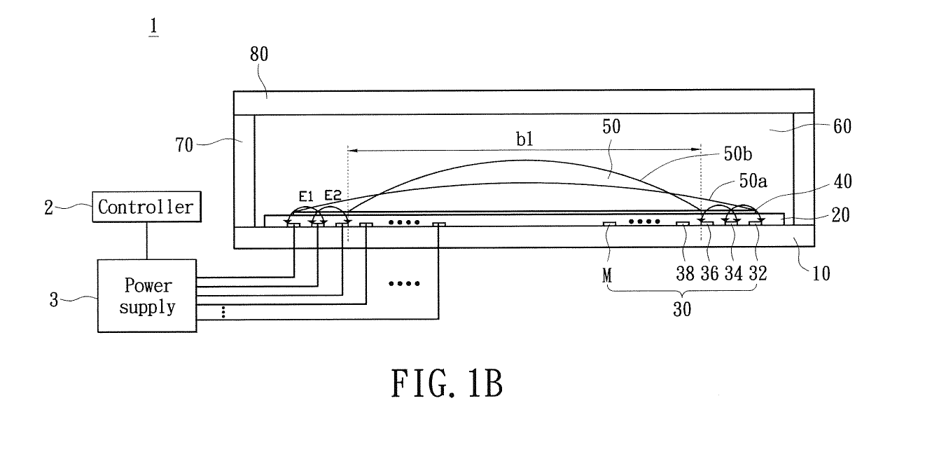

FIG. 1A is a top view of a liquid lens 1 driving method in accordance with an embodiment of the instant disclosure and FIG. 1B is a cross-sectional view of the liquid lens 1 driving method in accordance with the embodiment of the instant disclosure. The cross-sectional view in FIG. 1B is provided based on a section line A-A cutting through the liquid lens 1 as shown in FIG. 1A. Please refer to FIG. 1A. The drive of the liquid lens 1 is control by a controller 2 and a power supply 3. Please refer to FIG. 1B. Specifically, the liquid lens 1 includes a substrate 10, an insulating layer 20, a driving electrode 30, a low surface energy layer 40, a first liquid 50, a second liquid 60, a container 70, and a transparent cover 80.

The driving electrode 30 is configured above the substrate 10. The quantity M of the driving electrode is a positive integer and is equal to or larger than two. In other words, the liquid lens 1 includes two or more driving electrodes 30. The driving electrodes 30 are annular in shape and concentrically configured to each other.

In FIG. 1A, four concentrically configured electrodes, a first electrode 32, a second electrode 34, a third electrode 36, and a fourth electrode 38 are provided as an example to disclose the instant embodiment. Specifically, the four concentrically configured electrodes are not in contact nor connected electrically. The driving electrodes 30 are sequentially configured from the outermost first electrode 32 to the second electrode 34, the third electrode 36, the fourth electrode 38, and to an innermost M^{th} electrode.

Notably, the driving electrodes 30 can be made of opaque and metallic materials such as molybdenum, chromium, copper or other conductive metal alloys. The driving electrodes 30 can also be made of transparent and conductive materials such as indium tin oxide (ITO), indium zinc oxide (IZO), or indium gallium zinc oxide (IGZO). In addition, any two adjacent and concentrically configured annular electrodes are spaced apart with a pre-determined distance of about 10 μm. However, the materials and the pre-determined distance are not limited herein.

Please refer again to FIG. 1B. The insulating layer 20 is configured above and covers the substrate 10 and the driving electrodes 30. Moreover, the insulating layer 20 can isolate the driving electrodes 30 to prevent breakdown voltage from occurring between any electrodes from the first electrode to the M^{th} electrode. In the instant embodiment, the insulating layer 20 has a thickness, which can be less than 2 μm. The insulating layer 20 can be made of transparent insulating materials such as resin, silica or polyimide. However, the thickness and materials of the insulating layer 20 are not limited herein.

The low surface energy layer 40 is configured above the insulating layer 20. The first liquid 50 is disposed on the low surface energy layer 40 and configured directly above the driving electrode 30. As shown in FIG. 1B, the low surface energy layer 40 is configured above the first electrode 32. The first liquid 50 and the low surface energy layer 40 are immersed in the second liquid 60. In the instant embodiment, the first liquid is non-polar liquids such as silicone oil and the second liquid 60 is polar liquids such as water or alcohol solutions such that the two liquids are immiscible. Moreover, the refractive index of the first liquid 50 is larger than the refractive index of the second liquid 60 in order to provide focus for the liquid lens 1.

The low surface energy layer 40 can be made of materials such as poly-para-xylene or polytetrafluoroethene. When the first liquid 50 is disposed on the low surface energy layer 40, a contact angle of the first liquid 50 can be less than 20°. However, the contact angle of the first liquid 50 is not limited herein. Moreover, due to the surface properties of the low surface energy layer 40, the frictional force between the first liquid 50 and the low surface energy layer 40 is small enough such that the energy required to deform is relatively low. As a result, low driving voltage is provided. In addition, in other embodiments, the insulating layer 20 of the liquid lens 1 can also be made of low surface energy materials such as integrally forming the insulating layer 20 with the low surface energy layer 40.

Moreover, as shown in FIG. 1B, the liquid lens 1 of the instant embodiment may include a container 70 and a transparent cover 80. The container 70, driving substrate, and the transparent cover 80 cooperatively form an enclosed chamber. The first and second liquid 50, 60 can be disposed in the enclosed chamber. The structure of the container 70 and the cover 80 can prevent leakage and evaporation of the first and second liquid 50, 60 whether in storage or in motion.

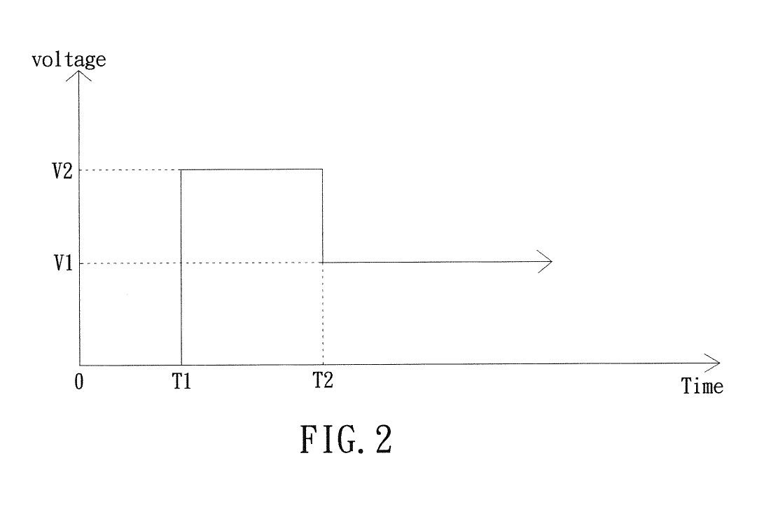

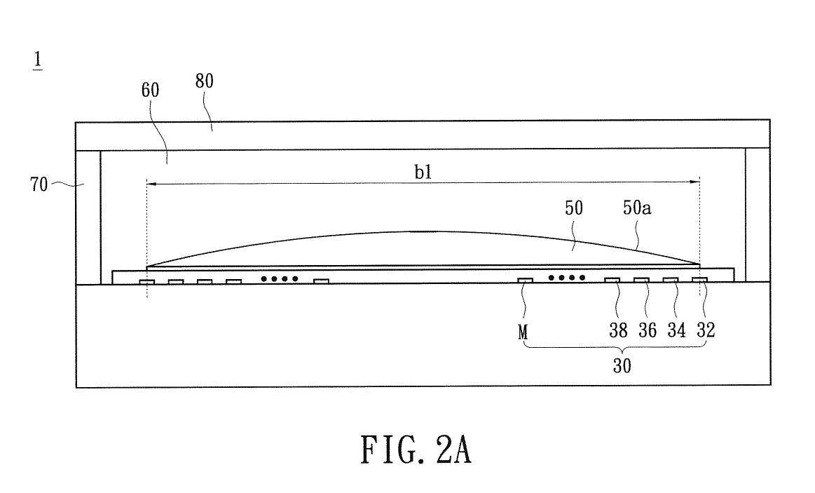

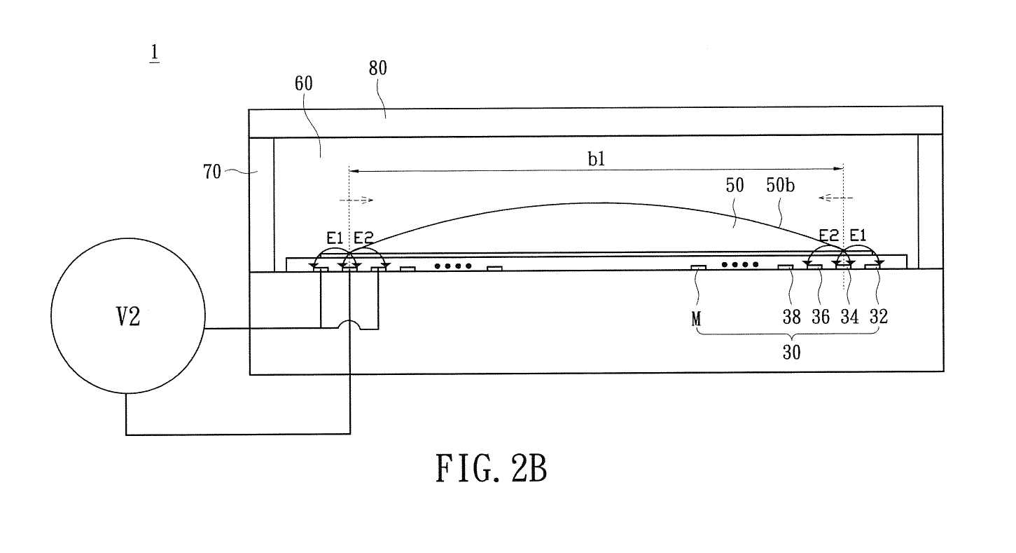

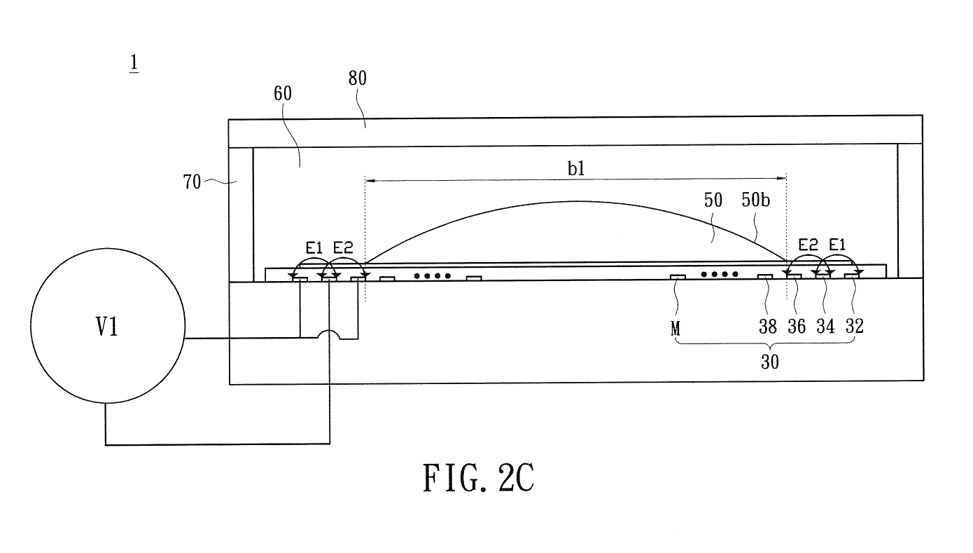

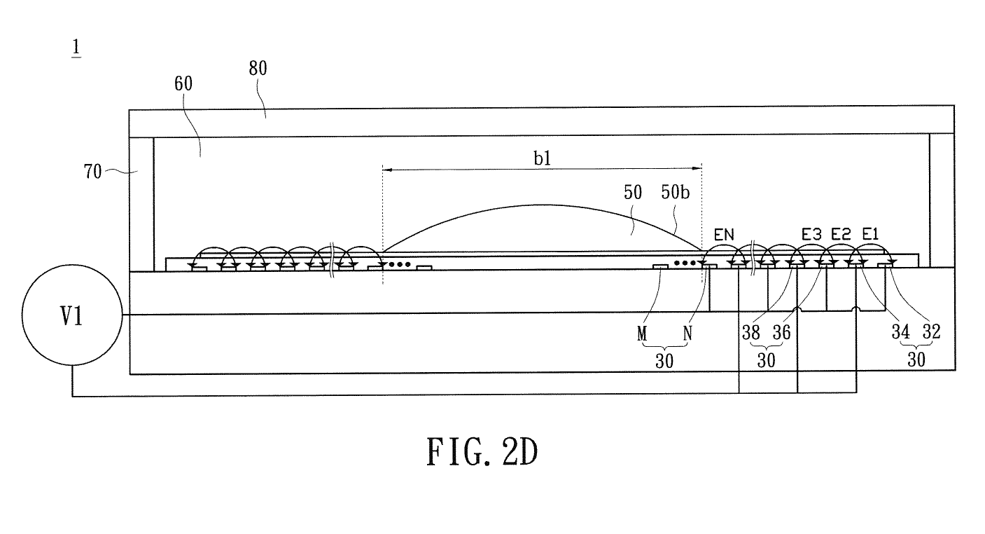

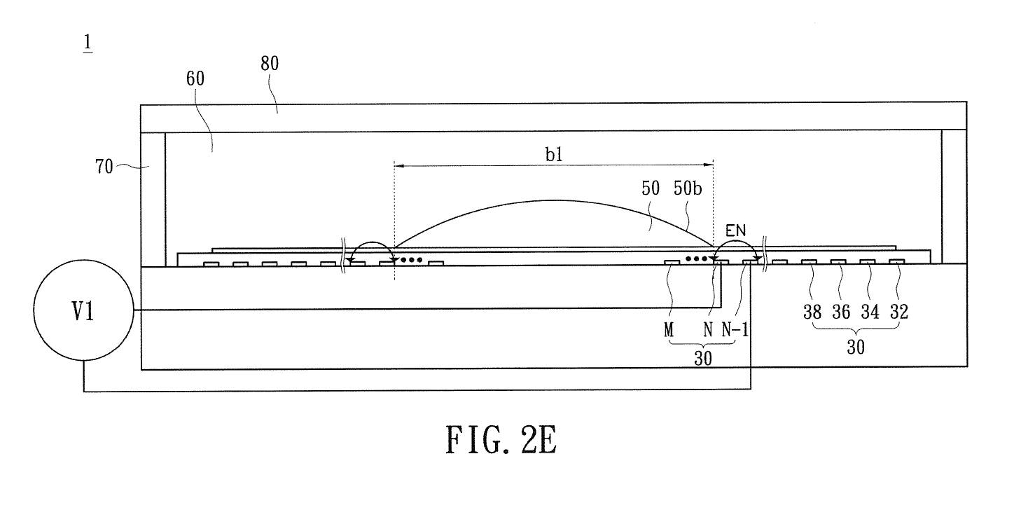

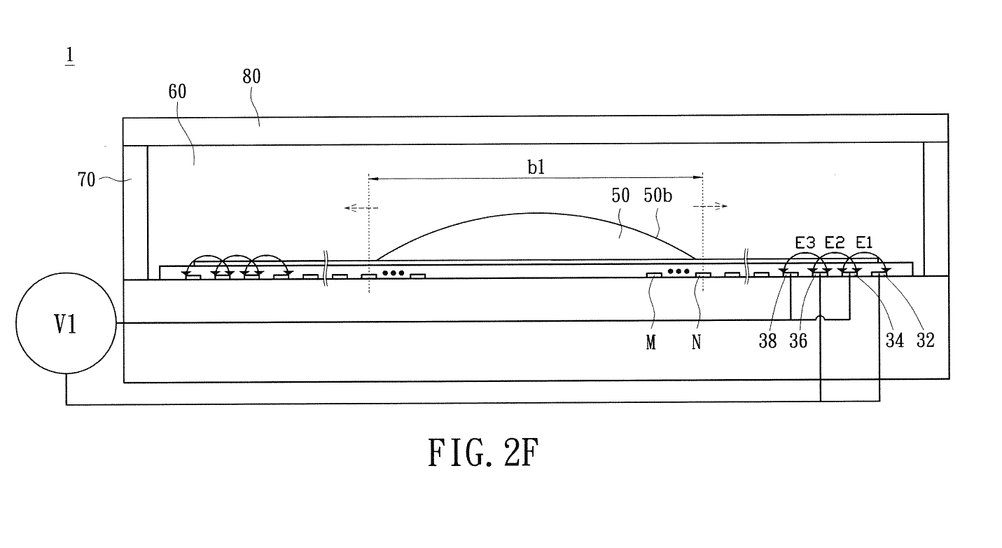

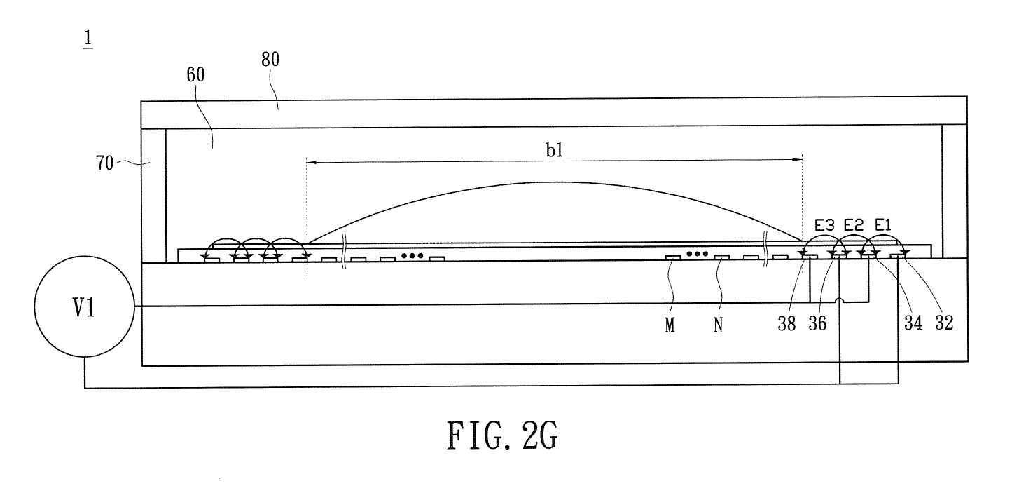

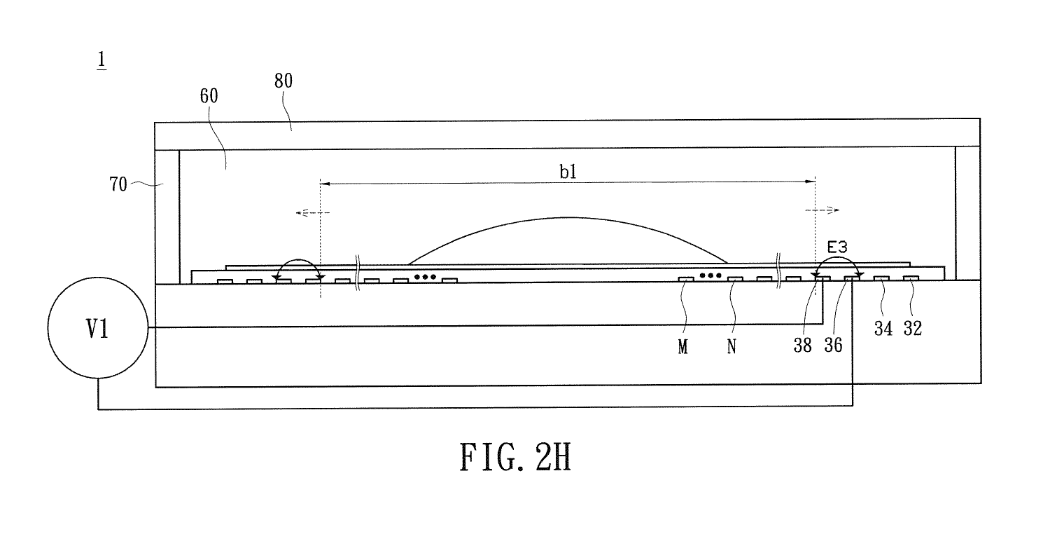

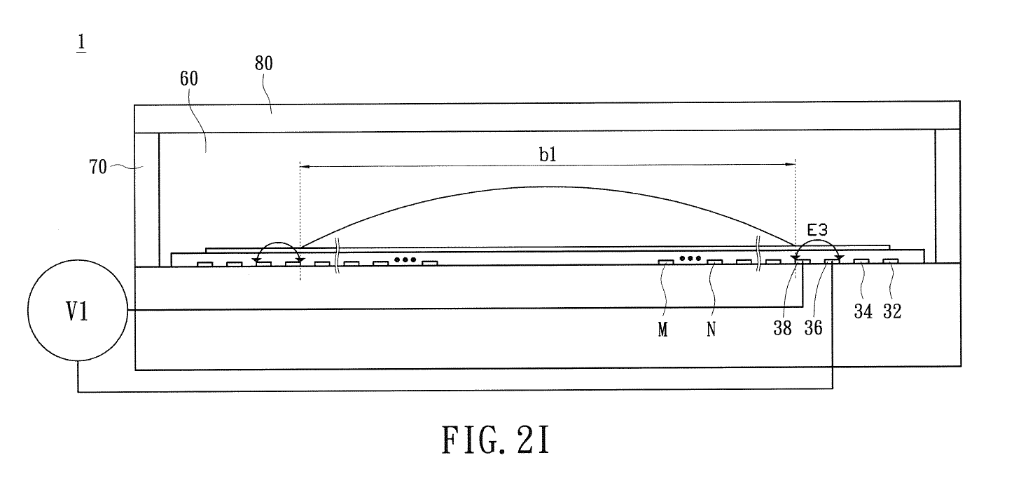

The aforementioned disclosure, the structure of the instant embodiment, in cooperation with the illustrations according to FIG. 1B disclose the driving method of the liquid lens 1. FIGS. 2 to 2I are schematic diagrams of the liquid lens driving method in accordance with the first embodiment of the instant disclosure.

In the instant embodiment, liquid lens 1 includes the driving electrodes 30. As aforementioned, M annular shaped driving electrodes 30 are concentrically configured with respect to each other, where M is larger than or equal to two. As an example, the instant embodiment only provides the first electrode 32, the second electrode 34, the third electrode 36, the fourth electrode 38, and the M^{th} electrode to disclose the driving mechanism which drives a base circumference b1 of the first liquid 50 to various inner circumferences of the concentrically configured annular electrodes.

The controller 2 and the power supply 3 (as shown in FIG. 1B) of the liquid lens 1 provide and control the voltage which drives the deformation of the first liquid 50. Please refer to FIG. 2, which shows the voltage as a function of time T for the driving method of the liquid lens 1. The driving method of the liquid lens 1 has three phases which are correspondingly represented by FIGS. 2A to 2C. As illustrated in FIG. 2A, one phase is when voltage is as not yet applied as time T is from zero to T1. As illustrated in FIG. 2B, another phase is when a driving voltage V2 (V_{driving}) is applied as time T is from T1 to T2, in which T1 is the time when the driving voltage V2 is initially applied whereas T2 is the time when the driving voltage V2 has been applied. As shown in FIG. 2C, another phase is when a holding voltage V1 (Vholding) is applied as time T is from after T2.

Notably, the liquid lens 1 driving method has two voltage input modes, one being the driving voltage V2, the other being the holding voltage V1. The driving voltage V2 drives the deformation of the first liquid 50 such that the base circumference of the first liquid 50 inwardly adjusts from the inner circumference of one concentrically configured annular electrode to the inner circumference of another concentrically configured annular electrode. In other words, the driving voltage V2 adjusts the focus from one focal length to another focal length. Moreover, in the instant embodiment, the liquid lens 1 only has one driving voltage V2. However, in other embodiments, the liquid lens 1 can have a plurality of driving voltages. For example, each of the driving electrodes 30 except for the first electrode 32, such as the second, third, or fourth electrode 34, 36, 38 can have one driving voltage individually, but is not limited herein.

The holding voltage V1 is a voltage which maintains the deformation of the first liquid 50, at which time, the holding voltage V1 is larger or equal to the minimum voltage necessary to maintain the deformation of the first liquid 50. Moreover, in the instant embodiment, the liquid lens 1 only has one holding voltage V1. However, in other embodiments, the liquid lens 1 can have a plurality of holding voltages. For example, each of the driving electrodes 30 except for the first electrode 32, such as the second, third, or fourth electrode 34, 36, 38 can have one holding voltage individually, but is not limited herein.

In the instant embodiment, the driving voltage V2 provided by the power supply 3 is larger than the holding voltage V1 of the liquid lens 1. As the driving voltage V2 become larger, the deformation of the first liquid 50 also becomes faster. In other words, the speed in which the first liquid 50 deforms depends on the value of the driving voltage V2 provided by the power supply 3.

Please refer to FIGS. 2 and 2A. When time T is within zero to T0, voltage is not yet applied to the electrodes 30. The first liquid 50 has a curved surface 50a when voltage is not applied. Meanwhile, the base circumference b1 of the first liquid 50 is substantially above the first electrode 32. Please refer to FIG. 2B. Thereafter, when time T is within T0 to Tdriving, the power supply 30 provides one driving voltage V2 to the electrode 30. The first liquid 50 has another curved surface 50b when voltage is applied.

Specifically in FIG. 1B, the controller 2 sends a signal in order to control the power supply 3 to provide one driving voltage V2 to the first, second, and third electrodes 32, 34, 36. As a result, the first and second electrodes 32, 34 develop a first electric field E1 therebetween, and the second and third electrodes 34, 36 develop a second electric field E2 therebetween. Meanwhile, the base circumference of the first liquid 50 will be inwardly displaced from above the first electrode 32 to above the third electrode 36 due to the effect of the electric field. Notably in the instant embodiment, the voltage applied by the power supply 3 is alternating current voltage (AC voltage), but is not limited to the example provided herein. The driving voltage V2 can also be direct current voltage (DC voltage).

The adjustment of the focal length of a liquid lens 1 from a long length to a short length is relative to the control of the shape of the first liquid deforming from the original shape to a convex shape. The control is explained as followed. When the controller 2 sends out a signal, the power supply 3 provides a specific voltage to the first, second, and third electrodes 32, 34, 36, in which two adjacent and concentrically arranged annular electrodes are opposite polarities, such that two adjacent and concentrically arranged annular electrodes develop one electric field therebetween. When a liquid to liquid interface between the two liquids (first and second liquids) is affected by the electric field, surface polarization charge distribution will develop proximate to the interface. Under the effect of the electric field, an electric force is developed on the interface and applied from the insulating liquid with high dielectric constant (first liquid) towards the insulating liquid with low dielectric constant (second liquid). As a result of the electric force, the shape of the first liquid 50 changes or deforms, such that the base circumference b1 of the curved surface 50b of the first liquid 50 displaces towards the center of the concentrically configured electrodes 30. Since voltage is not applied to the fourth electrode 38, no electric field is present between the third and fourth electrode 36, 38. Successively, the base circumference b1 of the curved surface 50b of the first liquid 50 displaces to the inner circumference of the third electrode 36. Focus adjustment of the liquid lens 1 is not depended on the value of the voltage provided but depended on the electrodes in which voltage are provided to. Thus, the control accuracy of the focal length of the liquid lens 1 is depended on the accuracy of the dimensions on the electrodes. The dimensions on the electrodes are the sub-micron dimensions formed by the semiconductor lithography process.

The adjustment of the focal length of a liquid lens 1 from a long length to a short length in another embodiment is relative to the control of the shape of the first liquid deforming from the original shape to a convex shape. When the controller 2 sends a signal, the power supply 3 provides a specific voltage to the second liquid and the first, second, and third electrode 32, 34, 36. At such time, the first, second, and third electrodes 32, 34, 36 have the same polarity and while having polarity opposite the second liquid. An interface between the second liquid and each of the first, second, and third electrodes 32, 34, 36 develops an electric field. When the charged ions proximate to the interface of the second liquid is affected by the electric field, the first liquid 50 will begin to deform such that the base circumference b1 of the curved surface 50b of the first liquid 50 displaces inwardly towards the center of the concentrically configured electrodes 30. Since voltage is not provided to the fourth electrode 38, an electric field is not developed between the second liquid and fourth electrode 38. Successively, the base circumference b1 of the curved surface 50b of the first liquid 50 will be displaced to the inner circumference of the third electrode 36. Focus adjustment of the liquid lens 1 is not depended on the value of the voltage provided but depended on the electrodes in which voltage are provided to. Thus, the control accuracy of the liquid lens 1 is depended on the accuracy of the dimensions on the electrodes. The dimensions on the electrodes are the sub-micron dimensions are accurately formed by the semiconductor lithography process.

Please refer to FIG. 2B. For example, in order for the base circumference b1 of the curved surface 50b of the first liquid 50 to displace to the third electrode 36, the power supply 3 must provide one driving voltage V2 (Vdriving) to the first, second, and third electrodes 32, 34, 36. As a result of the voltage provided, the first and second electrodes 32, 34 develop a first electric field E1 therebetween, and the second and third electrodes 34, 36 develop a second electric field E2 therebetween (as shown in FIG. 2B).

The base circumference b1 of the curved surface 50b of the first liquid is first affected by the electric field E1 and is displaced to the second electrode 34, and then further affected by another electric field E2 and displaced to the third electrode 36. Since no electric field is present between the third and fourth electrode 36, 38, no forces are applied onto the curved surface of the liquid bead 50b, thus, the curved surface 50b of the first liquid 50 cease to displace towards the center of the concentrically configured electrodes 30.

Similarly, to displace the base circumference b1 of the curved surface 50b of the first liquid 50 to the second electrode 34 the power supply 3 is required to provide one driving voltage V2 to the first electrode 32 and the second electrode 34 such that the electric field E1 is present between the first and second electrode 32, 34. As a result, the base circumference b1 of the curved surface 50b of the first liquid 50 displaces to the second electrode 34 under the effect of the electric field E1.

Please refer to FIG. 2C. After the curved surface 50b of the first liquid 50 ceases to deform, a signal can be sent from the controller 2 to the power supply 3 to lower voltage to the holding voltage V1 (Vholding) such that the curved surface 50b of the first liquid 50 maintains on the third electrode 36. Notably, the liquid lens 1 requires relatively high voltage such as the driving voltage V2 for focus adjustments. However, the liquid lens 1 requires relative less voltage such as holding voltage V1 in order to maintain a particular focus, and thus, reducing power consumption.

Moreover, two modes can be taken to maintain the curved surface 50b of the first liquid 50 at a particular electrode. Please refer to FIG. 2D as an example. To displace the curved surface 50b of the first liquid 50 to the N^{th} electrode, the power supply 3 can provide driving voltages throughout all electrodes from the first 32 to the N^{th} electrode. Successively, the driving voltage V2 is adjusted to the holding voltage V1. Under the influence of an electric field EN between the N^{th} electrode and the N−1^{th} electrode, the curved surface 50b of the first liquid 50 maintains on the N^{th} electrode.

In the instant embodiment as shown in FIG. 2E, since the curved surface 50b of the first liquid 50 is only affected by the electric field EN between the N^{th} electrode and the N−1^{th} electrode, the holding voltage V1 can only be provided to the N^{th} electrode and the N−1^{th} electrode. Due to the influence of an electric field EN between the N^{th} electrode and the N−1^{th} electrode, the curved surface 50b of the first liquid 50 maintains on the N^{th} electrode.

The aforementioned discloses the curved surface 50b of the first liquid 50 deforms and displaces from the first electrode 32 towards the electrodes 30 proximate to the center of the concentric electrodes 30. The following discloses the curved surface 50b of the first liquid 50 deforms and displaces from the electrodes 30 proximate to the center of the concentric electrodes 30 towards the first electrode 32. In other words, the control of the focal length of the liquid lens 1 adjusting from short to long or returning to the original focal length is disclosed as followed.

More specifically, if after the curved surface 50b of the first liquid 50 is on the N^{th} electrode, the holding voltage V1 is not provided to the N^{th} electrode, but rather the holding voltage V1 is only provided throughout all electrodes from the first to the L^{th} electrode, the electric field EN between the N^{th} electrode and the N−1th electrode vanishes. At such time, the force on the interface of the curved surface 50b of the first liquid 50 similarly vanishes. Under the influence of surface tension, the curved surface 50b of the first liquid 50 outwardly displaces. In other words, the base circumference b1 of the curved surface 50b of the first liquid 50 outwardly expands towards the direction of the L^{th} electrode. Under the influence of the force between the L^{th} electrode and the L−1^{th} electrode, the base circumference b1 of the curved surface 50b of the first liquid 50 cease to expand at the L^{th} electrode, where the L^{th} electrode is any one electrode between the first and the N^{th} electrode and L is larger than two and smaller than N.

Please refer to FIGS. 2F and 2G for example, if after the curved surface 50b of the first liquid 50 is on the N^{th} electrode and the holding voltage V1 is not provided to the N^{th} electrode by the power supply 3 initiated by the signal sent from the controller 2, but rather the holding voltage V1 is only provided throughout all electrodes from the first to the fourth electrode, the electric field EN between the N^{th} electrode and the N−1^{th} electrode vanishes. At such time, the force on the interface of the curved surface 50b of the first liquid 50 similarly vanishes. Under the influence of surface tension, the curved surface 50b of the first liquid 50 outwardly displaces. In other words, the base circumference b1 of the curved surface 50b of the first liquid 50 outwardly expands towards the direction of the fourth electrode.

However, as the base circumference b1 of the curved surface 50b of the first liquid 50 outwardly expands to the inner circumference of the fourth electrode 38, the base circumference b1 of the curved surface 50b of the first liquid 50 ceases to displace due to the electric fields E3, E2, E1 respectively developed between the fourth and third electrodes 36, 38, the third and second electrodes 36, 34, and the second and first electrodes 34, 32. At such time, the electric fields developed by holding voltage V1 act upon the interface of the first liquid 50 such that the base circumference b1 of the curved surface 50b of the first liquid 50 ceases to displace (as shown in FIG. 2G).

Similarly, if voltage is not provided, by the power supply 3 initiated by a signal from the controller 2, to the fourth and third electrodes 38, 36, the curved surface 50b of the first liquid 50 is only affected and displaced by the electric field E1 developed between the first and the second electrode 32, 34. Thus, the curved surface 50b of the first liquid 50 is displaced to the second electrode 34. If the controller 2 sends a signal to the power supply 3 such that no voltage is provided to any of the electrodes 30, the curved surface 50b of the first liquid 50 returns to the pre-deformed state.

Furthermore, holding voltage V1 can be provided only to the L^{th} and the L−1^{th} electrode such that the curved surface 50b of the first liquid 50 is bounded by the L^{th} electrode. As shown in FIGS. 2H and 2I, when the curved surface 50b of the first liquid 50 is bounded by the fourth electrode 38, the controller 2 sends a signal to the power supply 3 to only provide the holding voltage V1 to the third and fourth electrodes 36, 38 while ceasing to provide the holding voltage V1 to the first and second electrodes 32, 34. At such time, since the curved surface 50b of the first liquid 50 is already bounded at the fourth electrode 38, only electric field E3 is necessary to maintain the curvature of the curved surface 50b of the first liquid 50. In addition, providing the holding voltage V1 to the first and second electrodes 32, 34 is not necessary, which further reduces the power consumption.

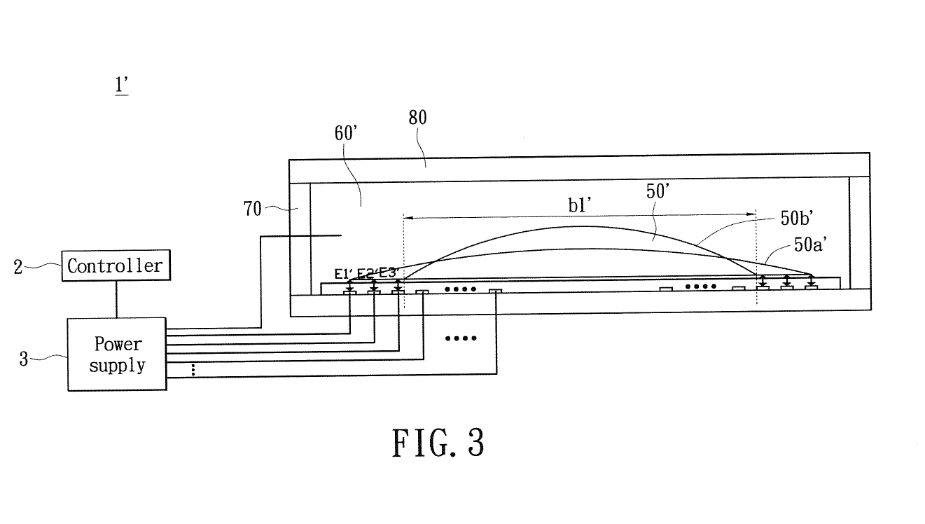

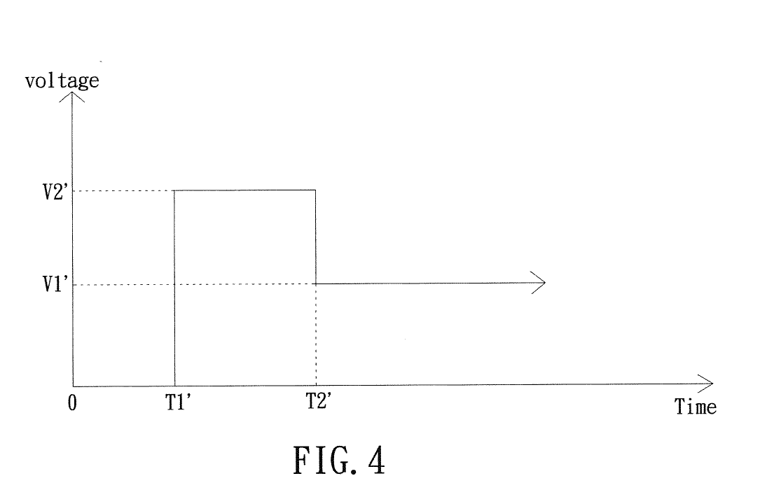

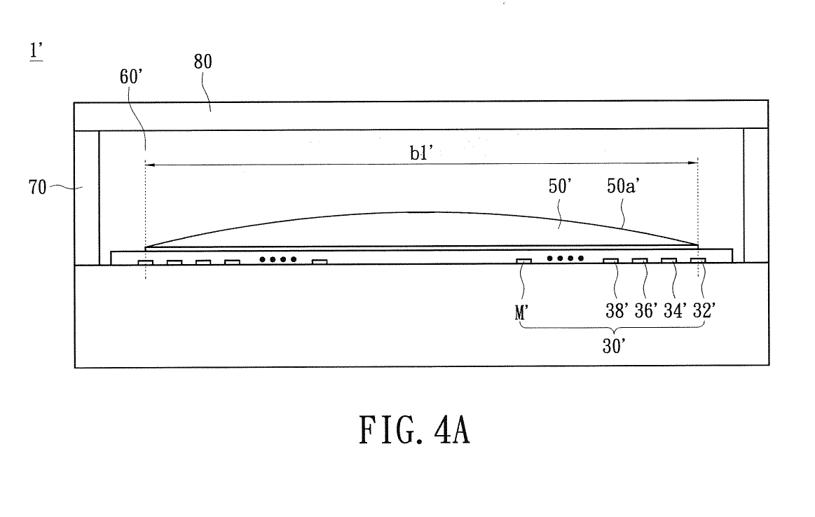

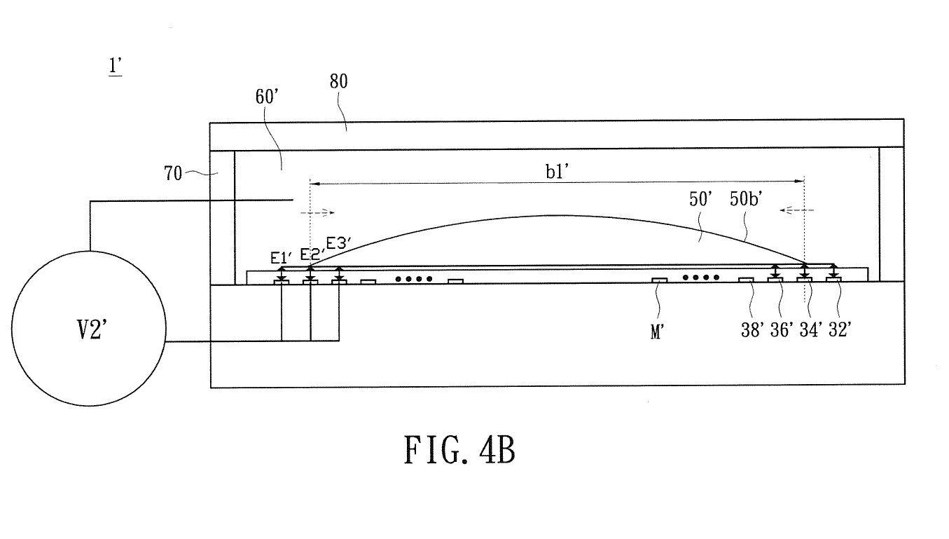

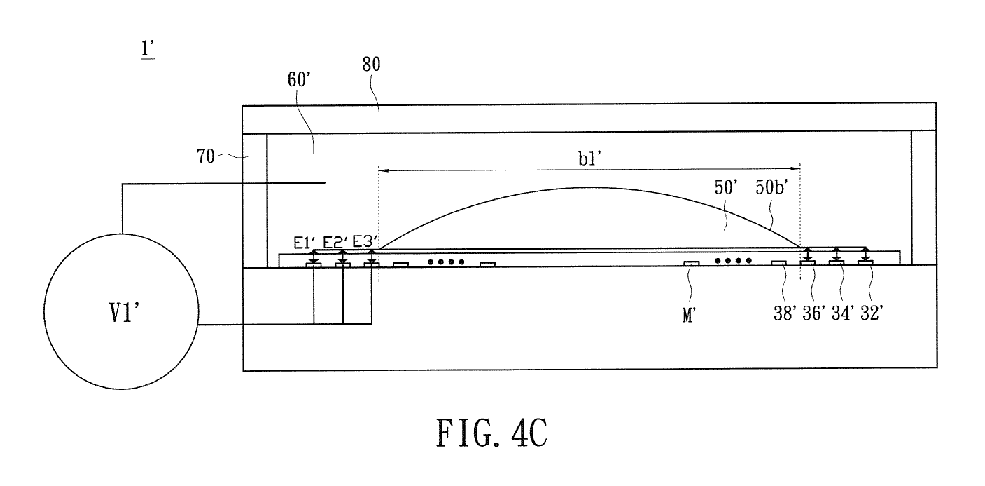

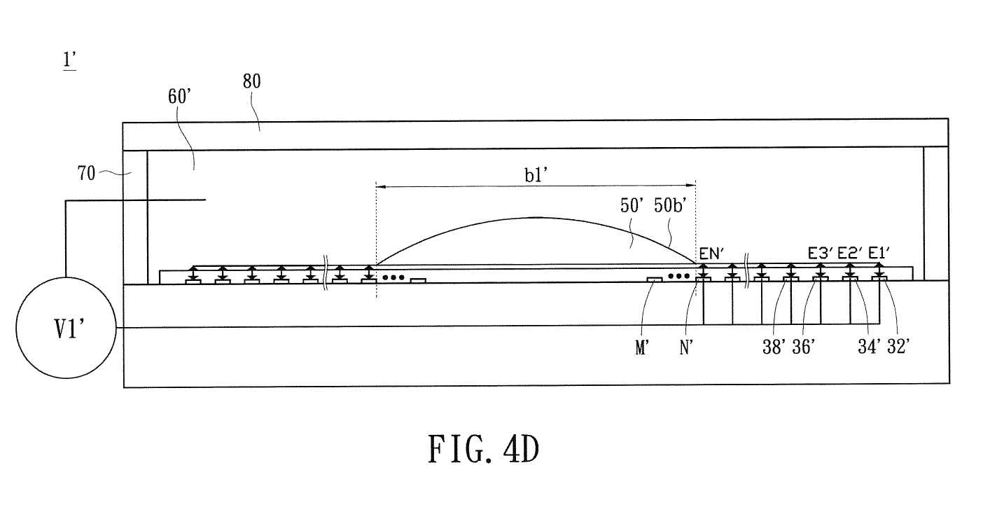

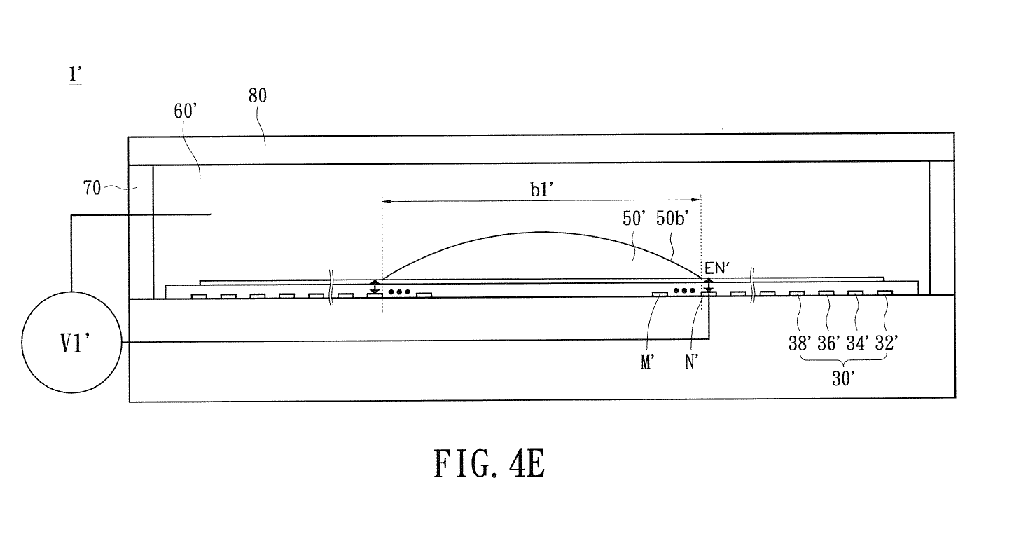

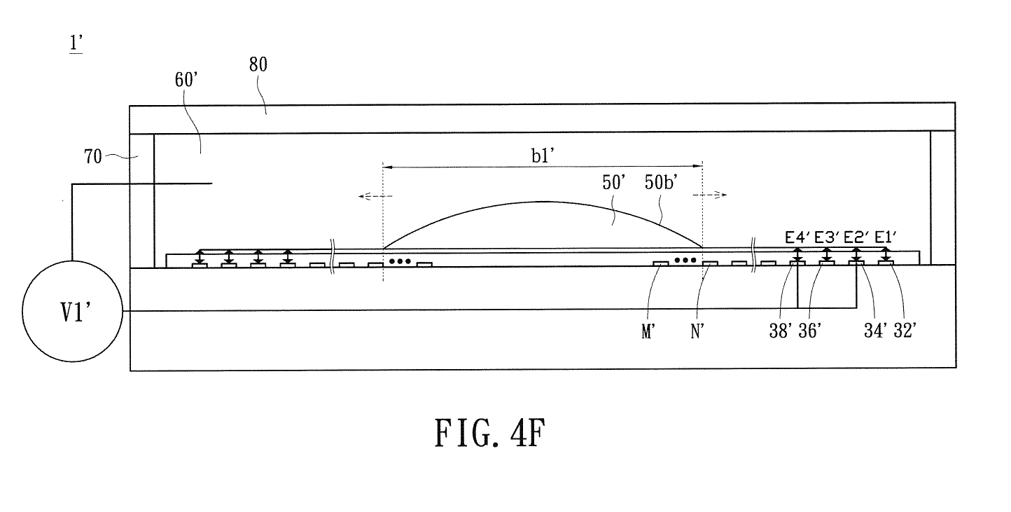

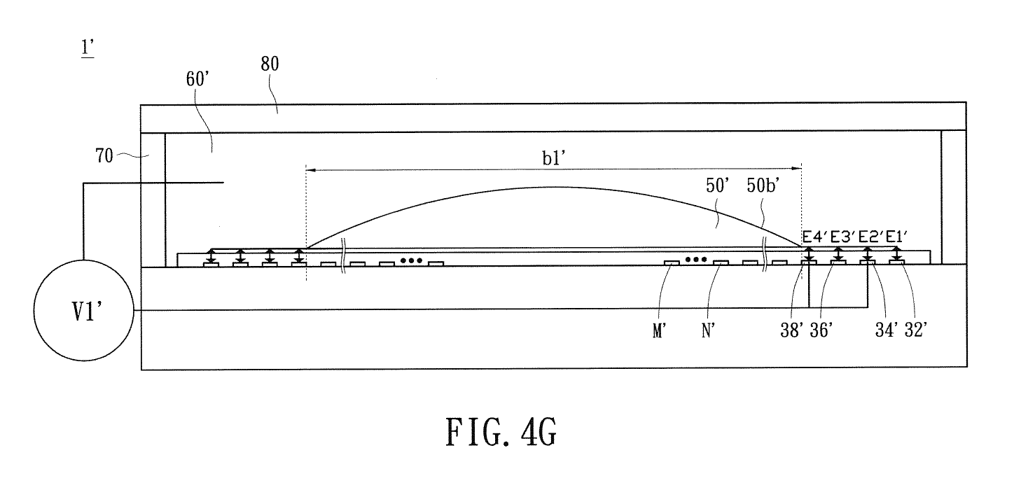

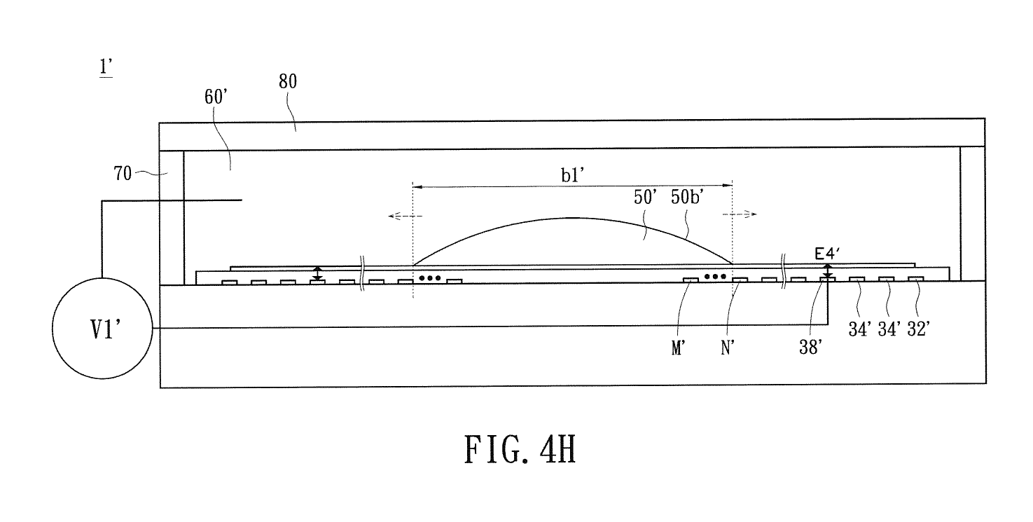

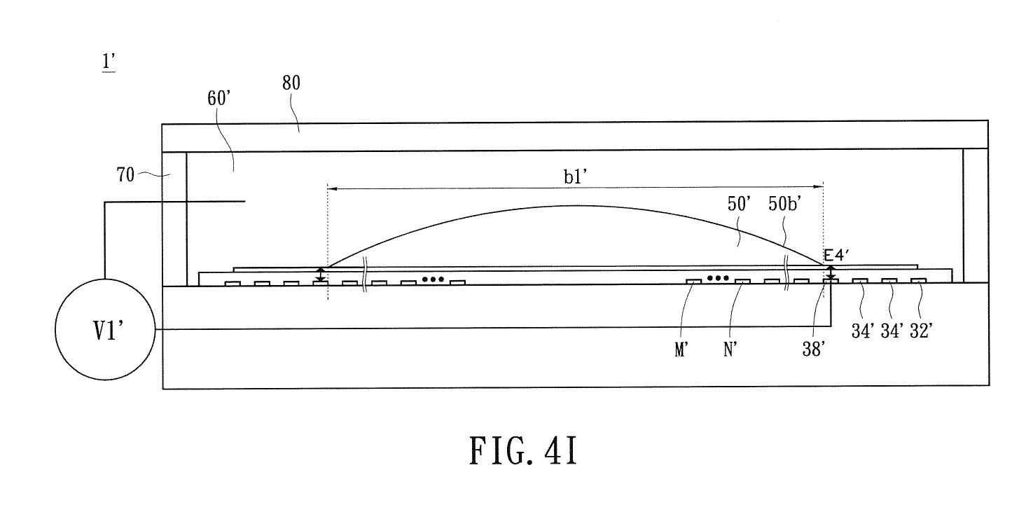

The disclosure above describes the first embodiment of the liquid lens 1 driving method while the following disclosure describes the second embodiment of the liquid lens 1 driving method. FIG. 3 is a cross-sectional view of the liquid lens driving method in accordance with a second embodiment of the instant disclosure. FIGS. 4 to 4I are schematic diagrams of the liquid lens driving method in accordance with the second embodiment of the instant disclosure. Please refer to FIG. 3, as the structure of the liquid lens 1 of the instant embodiment is substantially the same as the previous embodiment. However, in the instant embodiment, the second liquid 60′ is an electrode. When the power supply 3 provides voltage across the second liquid 60′, the first electrode 32′, the second electrode 34′, and the third electrode 36′, the second liquid 60′ and three electrodes (32′, 34′, 36′) respectively develop three electric fields E1′, E2′, E3′ (as shown in FIG. 3).

Please refer to FIGS. 4 to 4C for further details of the liquid lens 1 driving method. As shown in FIG. 4A, when voltage is not provided, the curved surface 50b′ of the first liquid 50′ is bounded substantially at the first electrode 32′. As shown in FIG. 4B, thereafter, when the power supply 3 provides voltage to either the first, second, or the third electrode 32′, 34′, 46′, the base circumference b1′ of the curved surface 50b′ of the first liquid 50′ displaces towards the concentric center of the electrodes. At such time, the base circumference of the first liquid 50′ also displaces towards the concentric center of the electrodes due to the influence of the electric field. Moreover, since no voltage is applied across the fourth electrode 38′, no electric field is developed between the second liquid 60′ and fourth electrode 38′. Successively, the base circumference b1′ of the curved surface 50b′ of the first liquid 50′ ceases to displace at the inner circumference of the third electrode 36′.

Please refer to FIG. 4C, once the deformation of the curved surface 50b′ of the first liquid 50′ stabilized, the controller 2 sends a signal to the power supply 3 in order to reduce the voltage to the holding voltage V1′ and to maintain the base circumference b1′ of the curved surface 50b′ of the first liquid 50′ at the third electrode 36′. As shown in FIGS. 4D and 4E are two modes in which the curved surface 50b′ of the first liquid 50′ is bounded at a particular electrode, for example, the N′^{th} electrode, where no deformation occurs. Please refer to FIG. 4D, when the base circumference b1′ of the first liquid 50′ is bounded at the N′^{th} electrode, the power supply 3′ can reduce the driving voltage V2′, which has been provided throughout the first electrode 32′ to the N′^{th} electrode, to the holding voltage V1′. At such time, the base circumference b1′ of the first liquid 50′ maintains at the N′^{th} electrode due to the effect of the electric field EN′ developed between the N′^{th} electrode and the second liquid 60′.

Since the first liquid 50′ maintains at the N′^{th} electrode, the first liquid 50′ is only effected by the electric field EN′ developed between the N′^{th} electrode and the second 60′. As a result, the holding voltage V1′ can only be provided to the N′^{th} electrode and the second 60′ as shown in FIG. 4E of other embodiments, and the base circumference b1′ of the first liquid 50′ maintains at the N′^{th} electrode due to the effect of the electric field EN′ developed between the N′^{th} electrode and the second 60′.

Moreover, FIGS. 4F to 4I illustrates the mode to displace the curved surface 50b′ of the first liquid 50′ from the inner electrode 30′ towards the direction of the first electrode 32′, which is the control of the focal length of the liquid lens 1 adjusting from short to long or returning to the original focal length. The aforementioned principles and modes are substantially the same as the first embodiment, and therefore not further explained.

In summary, in the liquid lens 1 driving method of the instant disclosure, when the controller 2 sends signal to the power supply 3 to provide one driving voltage V2 to the first to the N^{th} electrode (ex. the fourth electrode), the base circumference b1 of the curved surface 50b of the first liquid 50 deforms to the N^{th} electrode (ex. the fourth electrode). The deformation of the first liquid 50 depends on the positions of the concentrically configured annular electrodes provided with input voltages. The driving electrodes 30 of the liquid lens 1 has M concentrically configured annular electrodes such that the first liquid 50 can deform and be bounded by M−1 positions. In other words, the liquid lens 1 has M−1 focus value or values. Notably, N is a positive integer, and N is larger than two and less than M.

Moreover, when the base circumference b1 of the curved surface 50b of the first liquid 50 deforms to the N^{th} electrode, the controller 2 sends a signal to the power supply 3 to provide driving voltage V2 only to the N^{th} and N−1^{th} electrodes in order to reduce power consumption. When the curved surface 50b of the first liquid 50 deforms to the N^{th} electrode, the controller 2 can send a signal to the power supply 3 to not provide voltage to the N^{th} electrode. As a result, the base circumference b1 of the curved surface 50b of the first liquid 50 displaces from the N^{th} to the N−1^{th} electrode.

Furthermore, liquid lens 1 can have one or more holding voltage V1. When the liquid lens 1 has one holding voltage V1, the driving voltage V2 requires to be larger or equal voltage to the holding voltage V1. When the liquid lens 1 has a plurality of holding voltages V1, all electrodes 30 other than the first electrode 32 has one holding voltage V1. When the curved surface 50b of the first liquid 50 deforms to the N^{th} electrode, the driving voltage requires to be larger or equal to the holding voltage of the N^{th} electrode. In addition, when the driving voltage is larger than the holding voltage, the driving voltage is reduced to the holding voltage after the curved surface 50b of the first liquid 50 deforms in order to reduce power consumption.

Notably, the larger the driving voltage, the shorter amount of time is required for the curved surface 50b of the first liquid 50 to displace to the desired electrode 30. In other words, the curved surface 50b of the first liquid 50 reaches the desired focus in a shorter amount time, thus, reduces the time for the liquid lens to adjust focus.

The embodiments are explained through data. According to the relationship between the value of the voltage and the relative reaction time in an actual measurement of data during the driving of the liquid lens, when the input voltage is substantially equals to the minimum driving voltage of 30 volts, which bounds the curved surface 50b of the first liquid 50 at the inner circumference of one of the particular concentrically configured annular electrodes, the required reaction time is about 216 milliseconds. When the driving voltage is increased to 40 volts, the required reaction time is reduced to 88 milliseconds. When the driving voltage is increased to 60 volts, the reaction time is further reduced to 40 milliseconds, which is about one fifth of the time of the driving voltage at 30 volts.

Comparing the liquid lens 1 driving method as aforementioned to the conventional method, the liquid lens 1 driving method of the instant embodiment is similar to the digital lens. However, the liquid lens 1 driving method of the instant embodiment depends on the position of the electric field formed between the M^{th} and the M−1^{th} concentrically configured annular electrodes to control the deformation of the first liquid 50, and thus, various focal lengths are provided. As a result, the liquid lens 1 driving method of the instant embodiment not only expedite the deformation of the liquid lens 50, but also provides more accurate control of the deformation of the liquid lens 50 comparing to the conventional method, and thusly, relatively more precise focus.

In summary, the instant disclosure provides a liquid lens 1 driving method inputs control voltages via specific voltage input modes to the corresponding driving electrodes in order to control focus of the liquid lens. When the first liquid is driven to deform, the controller can send a signal to the power supply in order to provide the driving voltage throughout each electrode from the first to the N^{th} electrode. With the driving voltage provided, the first liquid deforms such that the base circumference b1 of the first liquid is bounded by the inner circumference of various concentrically configured annular electrodes in order to provide various focus. Moreover, the driving voltage must be larger than or equal to the holding voltage. The larger the difference between the driving voltage and the holding voltage, the faster the first liquid reaches the desired focus, thus, reducing the adjustment time of the liquid lens.

The figures and descriptions supra set forth illustrated the preferred embodiments of the instant disclosure; however, the characteristics of the instant disclosure are by no means restricted thereto. All changes, alternations, combinations or modifications conveniently considered by those skilled in the art are deemed to be encompassed within the scope of the instant disclosure delineated by the following claims.

What is claimed is:

1. A liquid lens driving method to control focus by providing voltages to a plurality (M) of driving electrodes with various voltage providing modes, M being at least 2, an outermost driving electrode being a first electrode, and an innermost driving electrode being a M^{th} electrode, comprising:
inputting a driving voltage throughout a first electrode to an N^{th} electrode, wherein N is at least 2 and at most equal to M, the liquid lens comprises a first liquid, a base circumference of the first liquid is displaced to the inner circumference of the N^{th} electrode, and the driving voltage adjusts the focus of the liquid lens; and
wherein when the base circumference of the first liquid is displaced to the inner circumference of the N^{th} electrode, the driving voltage is lowered to a holding voltage to maintain the shape of the first liquid, and the focus of the liquid lens.

2. The liquid lens driving method as recited in claim 1, wherein the driving voltage is substantially equal to or greater than the holding voltage.

3. The liquid lens driving method as recited in claim 1, wherein the liquid lens further comprising a second liquid mutually immiscible with the first liquid, and the first liquid is non-polar liquid and the second liquid is polar liquid.

4. The liquid lens driving method as recited in claim 1, wherein the electrodes are annular shaped electrodes concentrically configured with respect to one another.

5. The liquid lens driving method as recited in claim 4, wherein the step of inputting the driving voltage throughout the first electrode to the N^{th} electrode, two adjacent and concentrically configured electrodes have opposite polarities, and the two adjacent electrodes provide an electric field therebetween.

6. The liquid lens driving method as recited in claim 5, wherein the step of inputting the driving voltage throughout the first electrode to the N^{th} electrode, the base circumference of the first liquid is displaced to the inner circumference of the N^{th} electrode, as N is at least 2 and at most equal to M, and the driving voltage is lowered to the holding voltage to maintain the shape of the first liquid.

7. The liquid lens driving method as recited in claim 5, wherein when the base circumference of the first liquid is displaced to the inner circumference of the N^{th} electrode, the driving voltage is adjusted to the holding voltage, and the holding voltage is only provided to an N−1^{th} electrode and the N^{th} electrode.

8. The liquid lens driving method as recited in claim 5, wherein when the base circumference of the first liquid is displaced to the inner circumference of the N^{th} electrode, and the holding voltage is provided to a L^{th} electrode to the first electrode such that the base circumference of the first liquid is displaced to the inner circumference of the L^{th} electrode, as L is at least 2 and less than N.

9. The liquid lens driving method as recited in claim 5, wherein when the holding voltage is only provided to a L^{th} electrode and a L−1^{th} electrode such that the base circumference of the first liquid is displaced to the inner circumference of the L^{th} electrode, as L is at least 2 and less than N.

10. The liquid lens driving method as recited in claim 1 further comprising:
inputting the driving voltage to the second liquid; and
wherein the step of inputting the driving voltage throughout the first electrode to the N^{th} electrode and an electric field is provided between the second liquid and each of the electrodes.

11. The liquid lens driving method as recited in claim 10, wherein the step of inputting the driving voltage throughout the first electrode to the N^{th} and the second liquid, the base circumference of the first liquid is displaced to the inner circumference of the N^{th} electrode, as N is at least 1 and at most equal to M, and the driving voltage is lowered to the holding voltage to maintain the shape of the first liquid.

12. The liquid lens driving method as recited in claim 10, wherein when the base circumference of the first liquid is displaced to the inner circumference of the N^{th} electrode, the driving voltage is adjusted to the holding voltage, and the holding voltage is only provided to the N^{th} electrode, and the second liquid.

13. The liquid lens driving method as recited in claim 10, wherein when the base circumference of the first liquid is displaced to the inner circumference of the N^{th} electrode, and the holding voltage is provided to a L^{th} electrode to the first electrode, and the second liquid such that the base circumference of the first liquid is displaced to the inner circumference of the L^{th} electrode, as L is at least 1 and less than N.

14. The liquid lens driving method as recited in claim 10, wherein when the base circumference of the first liquid is displaced to the inner circumference of the N^{th} electrode, and the holding voltage is only provided to the L^{th} electrode, and the second liquid such that the base circumference of the first liquid is displaced to the inner circumference of the L^{th} electrode, as L is at least 1 and less than N.
